(19) United States
(12) Patent Application Publication
(10) Pub. No.: US 2013/0088404 A1
(43) Pub. Date: Apr. 11, 2013

(54) MULTI-FEED ANTENNA APPARATUS AND METHODS

(71) Applicants: Prasadh Ramachandran, Oulu (FI); Ari Raappana, Kello (FI); Petteri Annamaa, Oulunsalo (FI)

(72) Inventors: Prasadh Ramachandran, Oulu (FI); Ari Raappana, Kello (FI); Petteri Annamaa, Oulunsalo (FI)

(21) Appl. No.: 13/269,490

(22) Filed: Oct. 7, 2011

(51) Int. Cl. H01Q 21/24; H01Q 1/50; H01Q 1/52; H01Q 9/04

(52) U.S. Cl. 343/853; 343/700 MS; 343/861

(57) ABSTRACT

A space efficient multi-feed antenna apparatus, and methods for use in a radio frequency communications device. In one embodiment, the antenna assembly comprises three (3) separate radiator structures disposed on a common antenna carrier. Each of the three antenna radiators is connected to separate feed ports of a radio frequency front end. In one variant, the first and the third radiators comprise quarter-wavelength planar inverted-L antennas (PILA), while the second radiator comprises a half-wavelength grounded loop-type antenna disposed in between the first and the third radiators. The PILA radiators are characterized by radiation patterns having maximum radiation axes that are substantially perpendicular to the antenna plane. The loop radiator is characterized by radiation pattern having axis of maximum radiation that is parallel to the antenna plane. The above configuration of radiating patterns advantageously isolates the first radiator structure from the third radiator structure in at least one frequency band.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to antenna apparatus for use within electronic devices such as wireless radio devices, and more particularly in one exemplary aspect to a multi-band long term evolution (LTE) or LTE-Advanced antenna, and methods of tuning and utilizing the same.

### DESCRIPTION OF RELATED TECHNOLOGY

Internal antennas are an element found in most modern radio devices, such as mobile computers, mobile phones, Blackberry® devices, smartphones, personal digital assistants (PDAs), or other personal communication devices (PCDs). Typically, these antennas comprise a planar radiating plane and a ground plane parallel thereto, which are connected to each other by a short-circuit conductor in order to achieve the matching of the antenna. The structure is configured so that it functions as a resonator at the desired operating frequency. It is also a common requirement that the antenna operate in more than one frequency band (such as dual-band, tri-band, or quad-band mobile phones), in which case two or more resonators are used.

Increased proliferation of long term evolution (LTE) mobile data services creates an increased demand for compact multi-band antennas typically used in mobile radio devices, such as cellular phones. Typically, it is desired for an LTE-compliant radio device to support operation in multiple frequency bands (such as, for example, 698 MHz to 960 MHz, 1710 MHz to 1990 MHz, 2110 MHz to 2170 MHz, and 2500 MHz to 2700 MHz). Furthermore, radio devices will need to continue to support legacy 2G, 3G, and 3G+ air interface standards, in addition to supporting LTE (and ultimately LTE-A). Additionally, implementation of the various air interface standards vary from network operator and/or region based on the various spectrums implemented, such as for example in the case of inter-band carrier aggregation, which comprises receiving data simultaneously on two or more carriers located in different frequency bands. The two frequency bands allocated vary based on geographic region, as well as the spectrum owned by the particular network operator, thereby creating a multitude of possible band pair implementations.

Typical mobile radio devices implement a single-feed portioned RF front-end. The single-feed RF front-end normally includes one single-pole multi-throw antenna switch with a high number of throws connected to the different filters or diplexers to support the various modes of operation. Therefore, by increasing the number of modes of operation supported by the device, additional circuitry is required, which is problematic given both the increasing size constraints of mobile radio devices, and the desire for reduced cost and greater simplicity (for, e.g., reliability). In order for a single-feed RF-front end to support inter-band carrier aggregation, diplexers for the two frequency bands need to be simultaneously connected to the antenna feed. This is achieved by modifying the antenna control logic to have two simultaneously active switch throws. Hardwired duplexer matching is required between the antenna switch throws and the band duplexers. Different matching would be required for different combinations of inter-band carrier aggregation pairs, therefore making single-feed RF front-end impractical to support the various specific band pair implementations.

Accordingly, there is a salient need for a small form-factor radio frequency antenna solution which enables various operator-specific frequency band operational configurations using the same hardware.

### SUMMARY OF THE INVENTION

The present invention satisfies the foregoing needs by providing, inter alia, a space-efficient multi-feed antenna apparatus and methods of tuning and use thereof.

In a first aspect of the invention, a multi-feed antenna apparatus is disclosed. In one embodiment, the antenna apparatus includes a first antenna element operable in a first frequency region, first antenna element comprising a first radiator and a first feed portion, the first feed portion configured to be coupled to a first feed port, a second antenna element operable in at least a second frequency region and a third frequency region. The second antenna element includes a second radiator, a second feed portion configured to be coupled to a second feed port, and a third feed portion configured to be coupled to a third feed port. In one variant, the second frequency region includes a first carrier frequency and the third frequency region includes a second carrier frequency, and the second and the third feed portions cooperate to: (i) enable inter-carrier aggregation of the first carrier and the second carrier into a single band, and (ii) to obviate diplexer matching specific to the single band.

In another embodiment, a triple-feed antenna apparatus is disclosed which includes a first antenna element operable in a lower frequency band and comprising a first feed portion configured to be coupled to a first feed port, a second antenna element operable in a second frequency band and comprising a second feed portion configured to be coupled to a second feed port, and a third antenna element operable in an upper frequency band and comprising a third feed portion configured to be coupled to a third feed port. The first and third antenna elements are each configured to form a radiation pattern disposed primarily in a first orientation, and the second antenna element is configured to form a radiation pattern disposed primarily in a second orientation that is substantially orthogonal to the first.

In one variant, the antenna apparatus includes a matching network.

In another variant, the first, second and third antenna elements are disposed on a common carrier, at least a portion of the carrier being configured substantially parallel to a ground plane, the radiation pattern of the first and third antenna elements each comprise an axis of maximum radiation that is substantially perpendicular to the ground plane, and the radiation pattern of the second antenna element includes an axis of maximum radiation substantially parallel to the ground plane.

In another variant, the first antenna element and the third antenna element each comprise a quarter-wavelength planar inverted-L antenna (FILA), and the second antenna element includes a half-wavelength loop antenna.

In yet another variant, the antenna apparatus includes a common carrier, the common carrier having a dielectric element having a plurality of surfaces, the first antenna element and the third antenna element are disposed at least partly on a first surface of the plurality of surfaces, and the second antenna element is disposed at least partly on a second surface of the plurality of surfaces, the second surface being disposed substantially parallel to a ground plane of the antenna apparatus, and the first surface being disposed substantially perpendicular to the ground plane.

In a second aspect of the invention, a radio frequency communications device is disclosed. In one embodiment, the radio frequency device includes an electronics assembly comprising a ground plane and one or more feed ports, and a multiband antenna apparatus. The antenna apparatus includes a first antenna structure comprising a first radiating element and a first feed portion coupled to a first feed port, a second antenna structure comprising a second radiating element and a second feed portion coupled to a second feed port, and a third antenna structure comprising an third radiating element and a third feed portion coupled to a third feed port.

In one variant, the second antenna structure and second feed port are disposed substantially between the first and third antenna structures, and the antenna apparatus is disposed proximate a bottom end of the ground plane.

In another variant, the first and third radiating elements have radiation patterns which are substantially orthogonal to a radiation pattern of the second radiating element, and the substantially orthogonal radiation patterns provide sufficient antenna isolation between each radiating element to enable operation of the device in at least three distinct radio frequency bands.

In a third aspect of the invention, matching network for use with a multi-feed antenna apparatus is disclosed. In one embodiment, the matching network includes first, second, and third matching circuits configured to couple a radio frequency front-end to first, second, and third feeds, respectively, and the first, second, and third matching circuits each enable tuning of respective ones of antenna radiators to desired frequency bands.

In another embodiment, the matching network includes first, second and third matching circuits configured to couple a radio frequency transceiver to first, second, and third feeds, respectively, and the first, second, and third matching circuits each provide impedance matching to a feed structure of the transceiver by at least increasing input resistance of the first, second, and third feeds.

In another embodiment, the matching network includes first, second and third matching circuits configured to couple a radio frequency front-end to first, second, and third feeds, respectively, and wherein the first, second, and third matching circuits each provide band-pass filtration, such filtration ensuring low coupling between respective ones of first, second, and third radiators.

In a fourth aspect of the invention, a method of tuning a multi-feed antenna is disclosed. In one embodiment, the multi-feed antenna includes first, second and third radiating elements and associated first, second, and third feed ports and matching circuits, and the method includes tuning a reactance of at least one of the matching circuits so as to create a dual resonance response in the radiating element associated therewith.

In one variant, the tuning is accomplished via at least selection of one or more capacitance values within the at least one matching circuit.

In another variant, the first and the third radiating elements each comprise a planar inverted-L antenna (PILA)-type element, and the tuning a reactance of at least one matching circuit includes tuning the reactance associated with the first and the third circuits so as to produce multiple frequency bands within the emissions of the first and the third elements.

In a fifth aspect of the invention, a method of radiator isolation for use in a multi-feed antenna apparatus of a radio frequency device is disclosed. In one embodiment, the multi-feed antenna apparatus includes first, second, and third antenna radiating elements, and at least first, second, and third feed portions, and the method includes electrically coupling the first feed point to the first radiating element, the coupling configured to effect a first radiation pattern having maximum sensitivity along a first axis, and electrically coupling the second feed point to the second radiating element, the electric coupling configured to effect a second radiation pattern having maximum sensitivity along a second axis. The third feed portion is also electrically coupled to the third radiating element. The foregoing coupling configured to effect a third radiation pattern having maximum sensitivity along the first axis.

In one variant the second axis is configured orthogonal to the first axis, and the axis configurations cooperate to effect isolation of the first radiating element from the third radiating element.

In a sixth aspect of the invention, a method of using a multiband antenna apparatus is disclosed.

Further features of the present invention, its nature and various advantages will be more apparent from the accompanying drawings and the following detailed description.

### BRIEF DESCRIPTION OF THE DRAWINGS

The features, objectives, and advantages of the invention will become more apparent from the detailed description set forth below when taken in conjunction with the drawings, wherein:

FIG. 1 is an isometric view depicting placement of the triple-feed antenna apparatus placement on a portable device printed circuit board according to one embodiment of the present invention.

FIG. 1A is an isometric view further detailing the triple-feed antenna apparatus of the embodiment of FIG. 1.

FIG. 1B is an isometric view showing the loop-type radiator of the antenna apparatus embodiment shown in FIGS. 1 and 1A.

FIG. 2 is top elevation view showing a carrier and radiating elements of the triple-feed antenna apparatus in accordance with one embodiment of the present invention.

FIG. 2A is a side elevation view of the carrier and radiating elements of triple-feed antenna apparatus shown in FIG. 2.

FIG. 3 is a circuit diagram of the triple-feed matching circuitry in accordance with one embodiment of the present invention.

FIG. 4 is a top elevation view detailing a rolled-out structure of the radiating elements of the of the triple-feed antenna apparatus accordance with one embodiment of the present invention.

FIG. 5 is a plot of measured free space input return loss for the three antenna structure in addition to the isolation between the triple-feed ports in accordance with one embodiment of the present invention.

FIG. 6 is a plot of total efficiency (measured across the low band, B17 band, high band, and B7 band) for three exemplary antenna configurations in accordance with one embodiment of the present invention.

All Figures disclosed herein are © Copyright 2011 Pulse Finland Oy. All rights reserved.

### DETAILED DESCRIPTION OF THE PREFERRED EMBODIMENT

Reference is now made to the drawings wherein like numerals refer to like parts throughout.

As used herein, the terms “antenna,” “antenna system,” “antenna assembly”, and “multi-band antenna” refer without limitation to any apparatus or system that incorporates a single element, multiple elements, or one or more arrays of elements that receive/transmit and/or propagate one or more frequency bands of electromagnetic radiation. The radiation may be of numerous types, e.g., microwave, millimeter wave, radio frequency, digital modulated, analog, analog/digital encoded, digitally encoded millimeter wave energy, or the like.

As used herein, the terms “board”' and “substrate” refer generally and without limitation to any substantially planar or curved surface or component upon which other components can be disposed. For example, a substrate may comprise a single or multi-layered printed circuit board (e.g., FR4), a semi-conductive die or wafer, or even a surface of a housing or other device component, and may be substantially rigid or alternatively at least somewhat flexible.

The terms “frequency range”, “frequency band”, and “frequency domain” refer without limitation to any frequency range for communicating signals. Such signals may be communicated pursuant to one or more standards or wireless air interfaces.

As used herein, the terms “portable device”, “mobile computing device”, “client device”, “portable computing device”, and “end user device” include, but are not limited to, personal computers (PCs) and minicomputers, whether desktop, laptop, or otherwise, set-top boxes, personal digital assistants (PDAs), handheld computers, personal communicators, tablet computers, portable navigation aids, J2ME equipped devices, cellular telephones, smartphones, personal integrated communication or entertainment devices, or literally any other device capable of interchanging data with a network or another device.

Furthermore, as used herein, the terms “radiator,” “radiating plane,” and “radiating element” refer without limitation to an element that can function as part of a system that receives and/or transmits radio-frequency electromagnetic radiation; e.g., an antenna or portion thereof.

The terms “RF feed,” “feed,” “feed conductor,” and “feed network” refer without limitation to any energy conductor and coupling element(s) that can transfer energy, transform impedance, enhance performance characteristics, and conform impedance properties between an incoming/outgoing RF energy signals to that of one or more connective elements, such as for example a radiator.

As used herein, the terms “loop” and “ring” refer generally and without limitation to a closed (or virtually closed) path, irrespective of any shape or dimensions or symmetry.

As used herein, the terms “top”, “bottom”, “side”, “up”, “down”, “left”, “right”, and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

As used herein, the term “wireless” means any wireless signal, data, communication, or other interface including without limitation Wi-Fi, Bluetooth, 3G (e.g., 3GPP, 3GPP2, and UMTS), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, Long Term Evolution (LTE) or LTE-Advanced (LTE-A), analog cellular, CDPD, satellite systems such as GPS, millimeter wave or microwave systems, optical, acoustic, and infrared (i.e., IrDA).

### Overview

The present invention provides, in one salient aspect, a multi-feed (e.g., triple-feed) antenna apparatus for use with a radio device the antenna advantageously providing reduced size and cost, as well as improved antenna performance suitable for serving multiple operational needs using the same hardware configuration

In one embodiment, the antenna assembly includes three (3) separate radiator structures disposed on a common antenna carrier or substrate. Each of the three antenna radiators is connected to separate feed ports of a radio device radio frequency front end. In this embodiment, the first and the third radiators (that are connected to the first and third feed ports, respectively) comprise quarter-wavelength planar inverted-L antennas (PILA). The second radiator (connected to the second feed port) includes a half-wavelength grounded loop-type antenna, and is disposed in between the first and the third radiators. In one implementation, the second radiator further includes a slot structure, configured to effect resonance in the desired frequency band.

The first radiator is in the exemplary embodiment configured to operate in a lower frequency band (LFB), while the second radiator structure is configured to operate in multiple frequency bands. The third radiator is configured to operate in an upper frequency band (UFB).

The exemplary PILA radiators are characterized by radiation patterns having axes of maximum radiation that are perpendicular to the antenna plane (the carrier plane). The loop radiator is characterized by radiation pattern having an axis of maximum radiation that is parallel to the antenna plane. The above configuration of radiating patterns advantageously isolates the third radiator structure from the first radiator structure. In one variant, the third radiator structure is isolated from the second radiator structure over at least one frequency band.

By placing the loop radiator structure in between the two PILA structures, and the second feed between the first and third feeds, significant isolation of the first and third radiators from one another is achieved, thereby enhancing the performance of the antenna apparatus.

The exemplary multi-feed antenna apparatus and RF front-end also advantageously enable inter-band carrier aggregation. In one implementation, each of the aggregated bands is supported by a separate antenna radiator (for example, the second and the third radiators). In another implementation, the inter-band aggregation is achieved using the same element for both bands (for example, the third antenna radiator).

### Detailed Description of Exemplary Embodiments

Detailed descriptions of the various embodiments of the apparatus and methods of the invention are now provided. While primarily discussed in the context of radio devices useful with LTE or LTE-A wireless communications systems, the various apparatus and methodologies discussed herein are not so limited. In fact, many of the apparatus and methodologies of the invention are useful in any number of complex antennas, whether associated with mobile or fixed devices that can benefit from the multi-feed antenna methodologies and apparatus described herein.

### Exemplary Antenna Apparatus

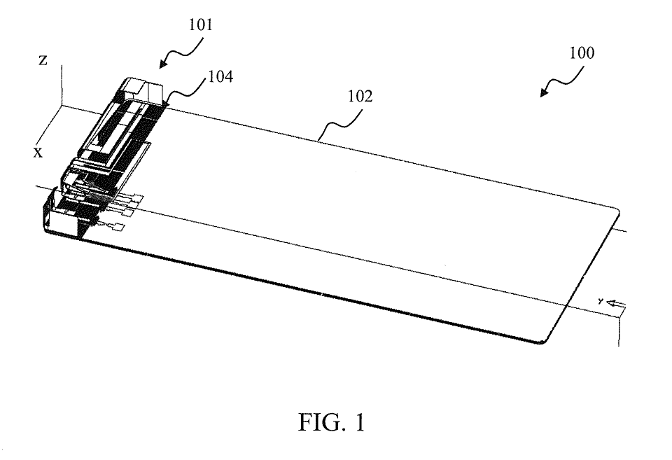

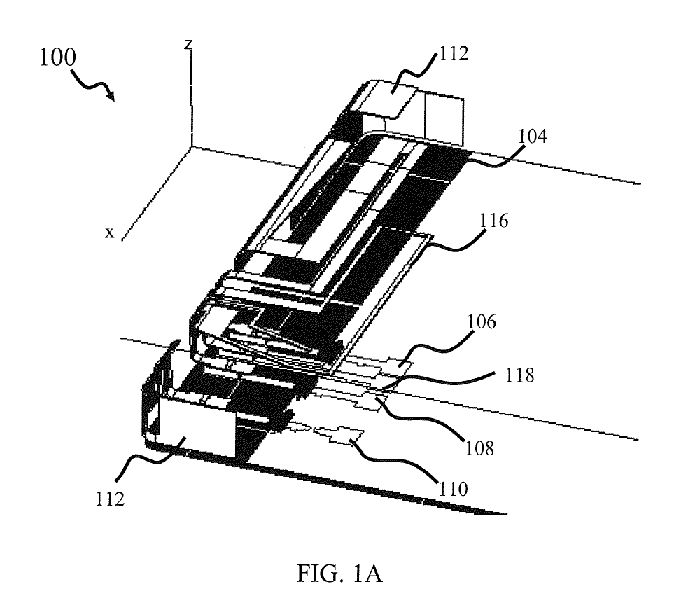

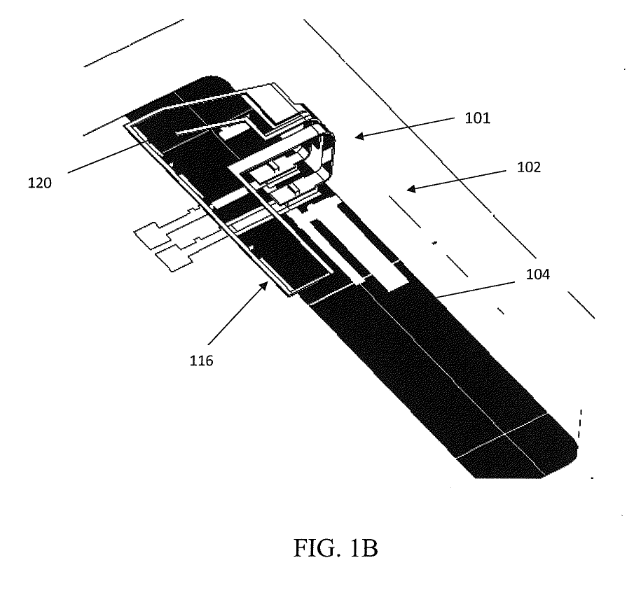

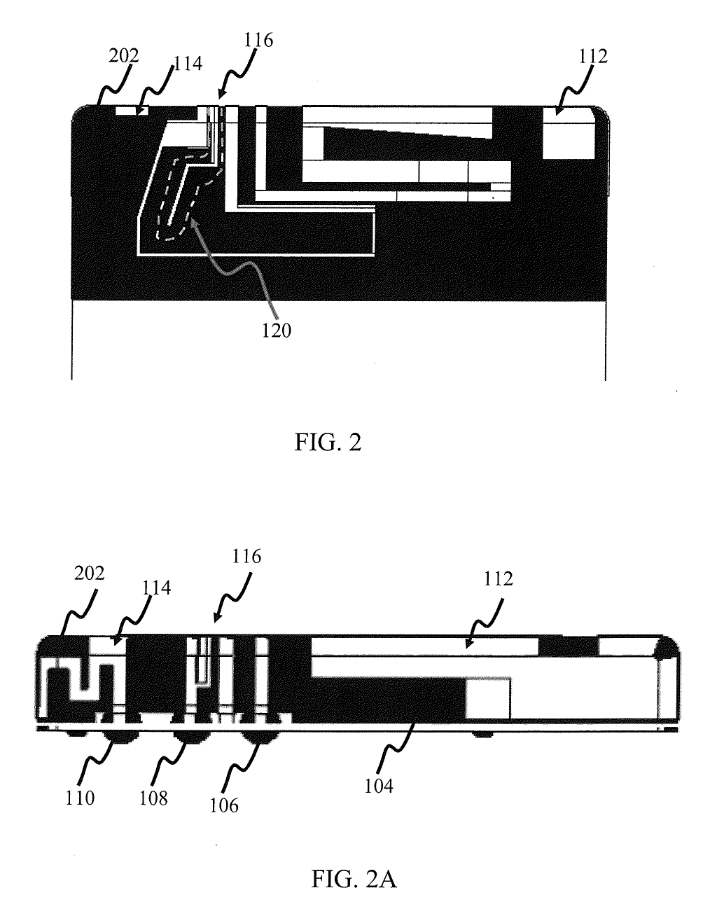

Referring now to FIGS. 1 through 2B, various exemplary embodiments of the triple-feed antenna apparatus of the invention are described in detail.

One exemplary embodiment of a multiband antenna apparatus 100 for use with a radio device is presented in FIG. 1, which shows an isometric view of the multi-feed antenna assembly 101 attached to a common printed circuit board (PCB) 102 carrier. The exemplary PCB 102 in this instance comprises a rectangle of about 100 mm (3.94 in.) in length, and about 50 mm (1.97 in.) in width. The PCB 102 further comprises a conductive coating (e.g., a copper-based alloy) deposited on the top planar face of the substrate element, so as to form a ground plane, depicted as the black area denoted by the reference number 104 in FIG. 1.

A detailed configuration of the multi-feed antenna assembly 101 is shown in FIG. 1A. The antenna assembly 101 comprises three separate radiator structures 112, 114, 116 disposed on a common antenna carrier (not visible in FIG. 1A, for clarity). Each of the three antenna radiators 112, 114, 116 is connected to separate feed ports 106, 108, 110, respectively, of a radio device radio frequency front end.

In one variant, the first feed port 106 covers a frequency range of approximately 700-960 MHz, known in LTE as the “Low Band”. The second feed port 108 covers approximately 1,425-1,505 MHz (band 11) as well as 2.3-2.7 GHz (bands 7, 40, and 41). The third feed port 110 is designed to cover approximately 1,710-2,170 MHz (high band). The exemplary bands referenced above are configured according to Evolved Universal Terrestrial Radio Access (E-UTRA) air interface specification, described in the 3rd Generation Partnership Project (3GPP) Technical Specification Group Radio Access Network (E-UTRA), 3GPP TS 36 series, incorporated herein by reference in its entirety. As will be appreciated by those skilled in the art, the above frequency band references and bounds may be varied or adjusted from one implementation to another based on specific design requirements and parameters, such as for example antenna size, target country or wireless carrier of operation, etc. Furthermore, embodiments of the present invention may be used with the High Speed Packet Access (HSPA) and 3GPP Evolved HSPA wireless communications networks, described in the 3rd Generation Partnership Project (3GPP) Technical Specification Group Universal Mobile Telecommunications System (UMTS);), 3GPP TS 25 series, incorporated herein by reference in its entirety. Typically, each of the operational frequency ranges may support one or more distinct frequency bands configured in accordance with the specifications governing the relevant wireless application system (such as, for example, HSPA, HSPA+, LTE/LTE-A, or GSM).

The multi-feed antenna apparatus and RF front-end (such as shown and described with respect to FIG. 1A) advantageously enable inter-band carrier aggregation. In one implementation, each of the aggregated bands is supported by a separate antenna radiator (for example, the second and the third radiators). In another implementation, the inter-band aggregation is achieved using the same antenna for both bands (for example, the third antenna). Notably, both configurations are supported using the same hardware configuration, and without requiring modification to the antenna switching logic (such as, for example, enabling two throws active at the same time), as separate feeds of the antenna 100 are used for different frequency bands.

The antenna configuration of the embodiment shown in FIG. 1 alleviates the need for band-pair specific duplexer matching, as required by the single-feed RF front-end and antenna implementations of prior art, as the needed isolation between the bands is provided by the separation of the antennas. As a brief aside, duplexer pair matching would still be a required in those implementations where the inter-band pair is close enough in frequency such that the same antenna would be used to receive both band pairs (e.g., band pair 2 and 4).

The first 112 and the third 116 radiators shown in the embodiment of FIG. 1A each (that are connected to the first and third feed ports, respectively) comprise quarter-wavelength planar inverted-L antennas (PILA). The second radiator (connected to the second feed port) comprises a half-wavelength grounded loop-type antenna, and is disposed in between the first and the third radiators. In one implementation, the second radiator further comprises a slot structure, configured to effect resonance in the desired frequency band. It will be appreciated that while PILA and loop-type antenna elements are selected for the first/third and second elements of the embodiment of FIG. 1, respectively, other types and/or combinations of antennas may be used consistent with the invention.

As shown in the embodiment of FIG. 1A, the radiator element 112 coupled to the first feed port 106 comprises a quarter-wavelength planar inverted-L antenna (PILA) structure disposed proximate to the corner edge of the PCB 102. The radiator element 114 coupled to the third feed port 110, also comprises a quarter-wavelength PILA type antenna structure disposed proximate to the opposite corner of the PCB 102 from the first PILA element 112. The other radiator element 116 is disposed between the PILA radiators 112 and 114, and is coupled to the second feed port 108. This third radiator 116 comprises a half wavelength loop-type antenna structure positioned proximate the (bottom) end of the PCB 102 and coupled to a ground point 118. The ground plane 104 is disposed as to reside substantially beneath the three radiator elements 112, 114, and 116. In the embodiment of FIG. 1A, the radiator elements 112, 114, 116 are formed as to have a ground clearance of approximately 9 mm (0.35 in.) parallel with the ground plane 104, although this value may be varied as desired or dictated by the application.

In one exemplary variant, the radiators elements 112, 114, and 116 are further configured to be bent over the edge of the device (as shown in FIG. 1A), thereby providing for improved coupling to the chassis modes, and maximizing impedance bandwidth. It will be appreciated that the placement of the antenna radiators 112, 114, and 116 can be chosen based on the device specification. However, the top or bottom edges are generally recognized to be the best locations for coupling to the chassis mode, thereby increasing antenna performance through maximizing impedance bandwidth (which is of particular importance for receiving lower frequencies such as the Low Band (700-960 MHz) within space-constrained devices).

The radiators 112, 114, and 116 of FIG. 1A can be fabricated using any of a variety of suitable methods known to those of ordinary skill, including for example metal casting, stamping, metal strip, or placement of a conductive coating disposed on a non-conductive carrier (such as plastic).

In the implementation shown in FIG. 1A, each radiator 112, 114, 116 is configured to resonate in a separate frequency range; i.e., the first (low band), third (high-band), and second range (B7, B11, B40), respectively. In another implementation of the multi-feed antenna (not shown), two of the feed ports (for example the ports 108, 106) share the same antenna radiator element. In one such variant, the single antenna (such as the antenna 116) is used to cover the 1 GHz and the 2 GHz frequency regions. As a brief aside, in sharing a single antenna, a diplexer may be used between the antenna and the antenna switches so as to prevent the duplexers from overloading each other, and thereby increasing insertion loss. However, the modularity (i.e., separability or ability to be replaced) of the RF front-end remains in such cases, as there is no need for band-pair specific duplexer matching (thereby obviating a specifically matched RF front-end). Therefore, different 1 GHz and 2 GHz carrier aggregation band pairs may be still supported with the same RF hardware configuration. Wireless operators of LTE-A networks desire a worldwide LTE roaming capability which typically requires carrier aggregation. Exemplary embodiments of the triple-feed antenna described supra advantageously provide a single antenna solution that covers all the required LTE frequency bands, thus satisfies carrier aggregation needs.

Referring now to FIG. 1B, a three-dimensional representation of the exemplary loop-type antenna radiator 116 described above is shown in detail. In one variant, the radiator 116 further comprises a slot-type structure 120 disposed within the loop assembly 122 of the radiator 116, which is designed to enable antenna resonance at an additional desired frequency (for example, 2.3 GHz), thereby expanding the operational frequency range of the radiator element 116.

The placement of the loop-type antenna structure 116 between the two PILA antenna structures 112 and 114 as shown in FIG. 1A enhances isolation between the three antenna feeds. By way of background, a small loop (having a circumference that is smaller than one tenth of a wavelength) is typically referred to as a “magnetic loop”, as the small loop size causes a constant current distribution around the loop. As a result, such small loop antennas behave electrically as a coil (inductor) with a small but non-negligible radiation resistance due to their finite size. Such antennas are typically analyzed as coupling directly to the magnetic field in the near field (in contrast to the principle of a Hertzian (electric) dipole, which couples directly to the electric field), which itself is coupled to an electromagnetic wave in the far field through the application of Maxwell's equations. In other words, the radiation pattern of the exemplary loop antenna structure 116 shown is similar to the radiation pattern of a magnetic dipole, with the axis of maximum radiation being perpendicular to the loop plane (i.e., along the z-dimension in FIG. 1A). Radiation patterns for the PILA antenna structures 112, 114 are similar to the radiation pattern of an electric dipole, with the axis of maximum radiation being parallel to the loop plane (along the x-dimension in FIG. 1A).

By placing the loop antenna structure 116 between the two PILA antenna structures 112, 114, the field ports achieve high isolation between the first and the third antenna structures. In addition, due to the orthogonal polarization of the loop 116 antenna and PILA antenna 114, the coupling between the antenna structures 114, 116 is greatly reduced (especially when considering the relative proximity of their operating frequency bands), thereby providing sufficient isolation between the frequency bands corresponding to the two antennas (for example a −12 dB isolation between 2.1 GHz and 2.3-2.6 GHz bands).

Referring now to FIG. 2, a top elevation view of the antenna assembly 101 is shown. The dark areas in FIG. 2 depict an antenna carrier 202 configured to support the conductive elements of antenna radiators 112, 114, 116. In one variant, the carrier 202 is fabricated from polycarbonate/acrylonitrile-butadiene-styrene (PC-ABS) that provides, inter alia, desirable mechanical and dielectric properties, although other suitable materials will be apparent to those of ordinary skill given the present disclosure. The slot structure 120 is denoted in FIG. 2 by the broken line curve.

FIG. 2A depicts a side elevation view of the antenna assembly 101 of FIG. 2. The antenna carrier 202 provides support for the radiator elements 112, 114, and 116, as well as providing the desired dielectric characteristics between the radiator elements 112, 114, and 116 and the ground plane 104.

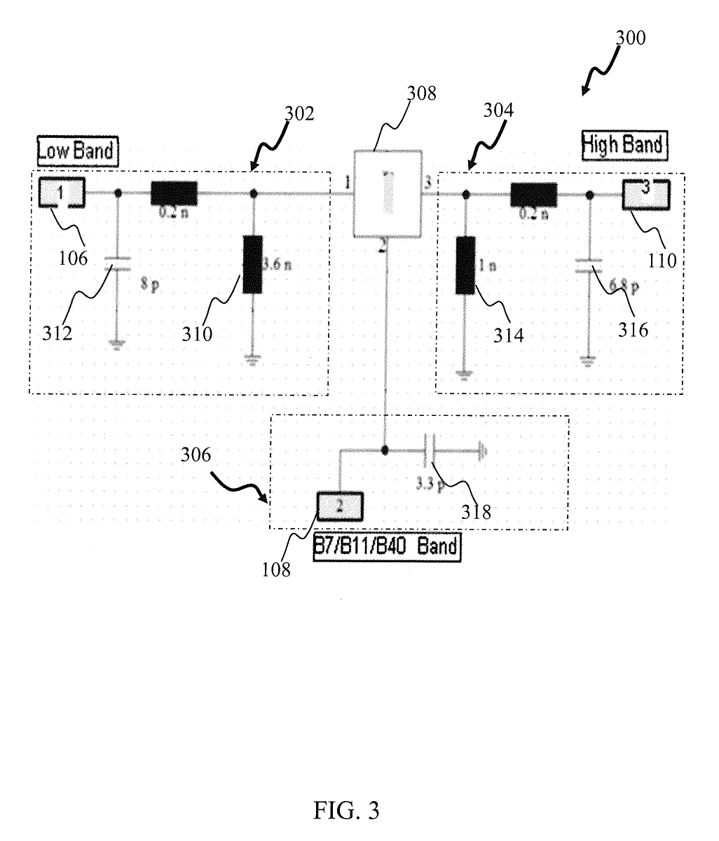

In another aspect of the invention, the triple-feed antenna assembly (such as the antenna assembly 101 of FIG. 1) comprises a matching network 300, one embodiment of which is illustrated in FIG. 3. The matching network 300 comprises the matching circuits 302, 304, 306 that are configured to couple the RF-front end 308 to the three feed ports 106, 108, 110 of the RF front-end. The purpose of the matching network 300 is to, inter alia, (i) enable precise tuning of the antenna radiators to their desired frequency bands; (ii) provide accurate impedance matching to the feed structure of the transceiver by increasing the input resistance of the feed ports 106, 108, 110 (for instance, in one implementation, to be close to 50 Ohms); and (iii) acts as band-pass filters ensuring low coupling between the radiators. The matching circuits 302, 304, 306 of the network 300 are configured to effectively filter out the higher-order cellular harmonics in a deterministic way.

By a way of example, PILA antenna radiators 112, 114 typically do not offer 50-Ohm impedance (radiational resistance) at their respective resonant frequencies F1, F3, as is desired for proper matching to the feed ports 106, 110. Hence, the matching network 300 is used to match the radiators 112, 114 to the feed ports as follows. The matching component of the circuits 302, 304 is selected to have resonances at frequencies Fm1=F1+X1, Fm3=F3+X3. In one variant, the frequencies Fm1, Fm3 are configured on exactly the opposite side of a Smith chart, with respect to frequencies F1, F3. The actual values of the frequency shift X1, X3 are determined by the respective antenna operating bands: i.e. LB/HB. In combination with the antenna radiators 112, 114, the matching circuits 302, 304 form a “dual resonance” type frequency response. Such frequency response effectively forms a band pass filter, advantageously attenuating out-of-band signal components and, hence, increasing band isolation. By way of example, the circuit 302 passes the LB signals and attenuates the HB/B7 signals, while the circuit 304 passes the HB signals and attenuates the LB/B7 signals.

The antenna 112, 114 isolation is further enhanced by the placement of the feed port 108 in-between the feed ports 106, 110. The use of a loop antenna structure (e.g., the structure 116) coupled to the feed port 108 further increase isolation between the feed ports 106, 110. Furthermore, the loop structure coupled to the fed port 108 enables to achieve high isolation between the feed port 108 and the radiators 112, 114.

In another embodiment, a PILA radiator structure is coupled to the feed-port 108 in place of the loop structure 116. Such configuration advantageously increases the isolation between the feed ports 106, 110. However, the feed 108 to radiator 112, 114 isolation may be reduced when the frequency band spacing (gap) between the HB and the feed port 108 frequency band becomes narrow, as illustrates by the examples below.

### EXAMPLE 1

Feed port 106: LB (PILA), feed port 108: 2.5-23 GHz (PILA), feed port 110: HB (PILA). This configuration provides sufficient feed to radiator isolation between the feed ports 108 and 110 due to a wide frequency gap (about 200 MHz) between the feed port 108 and 110 frequency bands.

### EXAMPLE 2

Feed port 106: LB (PILA), feed port 108: 2.3-2.7 GHz (PILA), feed port 110: HB (PILA). This configuration does not provide sufficient feed to radiator isolation between the feed ports 108 and 110 due to a small frequency gap (about few MHz) between the feed port 108 and 110 frequency bands.

### EXAMPLE 3

Feed port 106: LB (PILA), feed port 108: 2.3-2.7 GHz (Loop), feed port 110: HB (PILA). This configuration provides very good feed to radiator isolation for all feed ports in all frequency bands despite a small frequency gap between the feed ports 108 and 110 frequency bands.

In one embodiment, the matching circuits for the first and third feed ports are realized through use of tapped inductors 310, 314, respectively. The inductor 310, 314 are implemented, in one variant, as narrow conductive traces on the PCB, configured to achieve the desired inductance values. In another variant, the inductors 310, 314 are implemented using discrete components, e.g. chip inductors, wound toroids, ceramic multilayer, and wire-wound inductors, etc. Residual reactance of the circuits 302, 304 can be tuned with the shunt capacitors 312, 316, respectively, so as to create a dual resonance type of response in the first and third feed ports 106, 108. The matching circuit 308, corresponding to the feed port 108, is properly matched over the target frequency range using a shunt capacitor 318. In other implementations, additional matching components may be used expand the resonance response of the radiators 112, 114, and 116 in order to cover additional desired frequency bands.

In order to minimize space occupied by the antenna assembly 101 of FIG. 1, the matching network 300 of the illustrated embodiment is directly fabricated on the lower portion of the PCB substrate 102. In other implementation, the matching network is disposed.

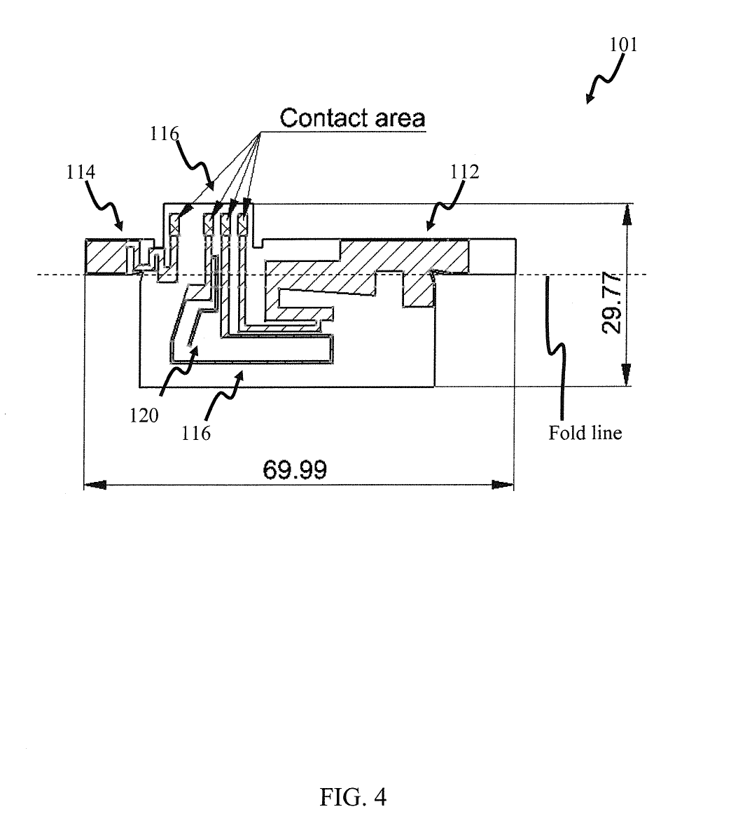

Referring now to FIG. 4, a “rolled out” (i.e., flattened) view of the antenna radiator structure 101 of the embodiment of FIGS. 1A, and 2-2A is shown in detail. Specifically, FIG. 4 more clearly illustrates the shape and disposition of the antenna radiators of the exemplary device as shown and described, supra, with respect to FIG. 1A. The dashed line in FIG. 4 denotes the fold line, used to fold the antenna radiator assembly around the carrier 202, as shown in FIGS. 2-2A herein. In addition, the slot type element 120 (part of the loop-type radiator 116) can be more clearly viewed.

In one exemplary implementation, the radiator elements 112, 114, and 116 are fabricated using stamped metal sheet of approximately 70 mm (2.76 in.) in length and 30 mm (1.18 in.) in width, although these dimensions may vary depending on the application and desired performance attributes. It is appreciated by those skilled in the arts that other fabrication approaches and/or materials are compatible with the invention including without limitation use of flex circuits, metal deposition, plated plastic or ceramic carrier, or yet other technologies.

### Performance

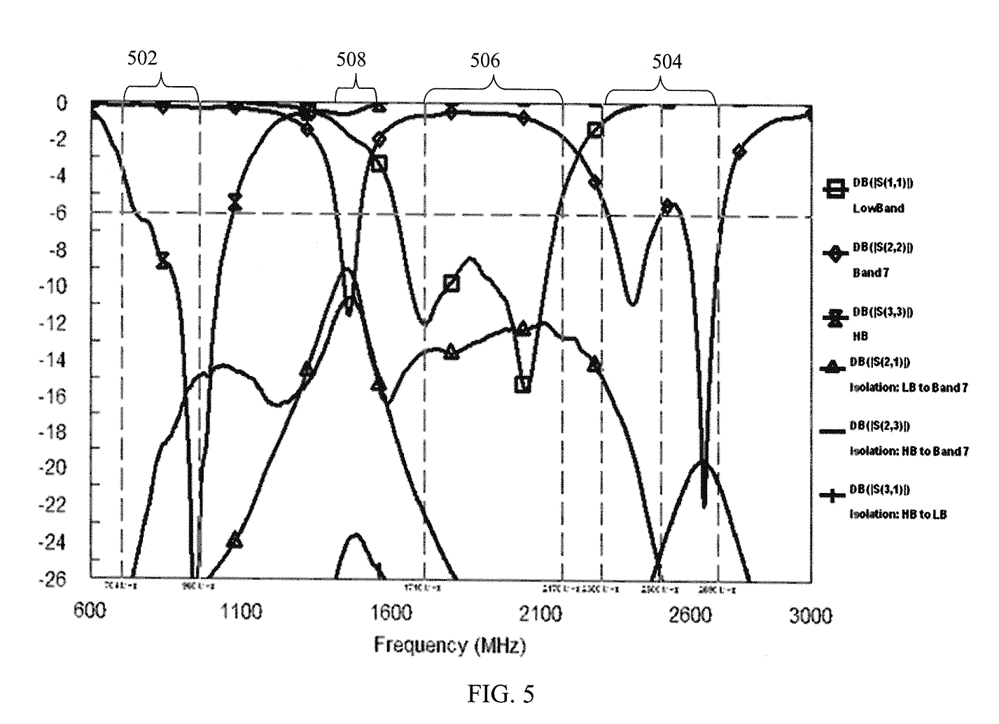

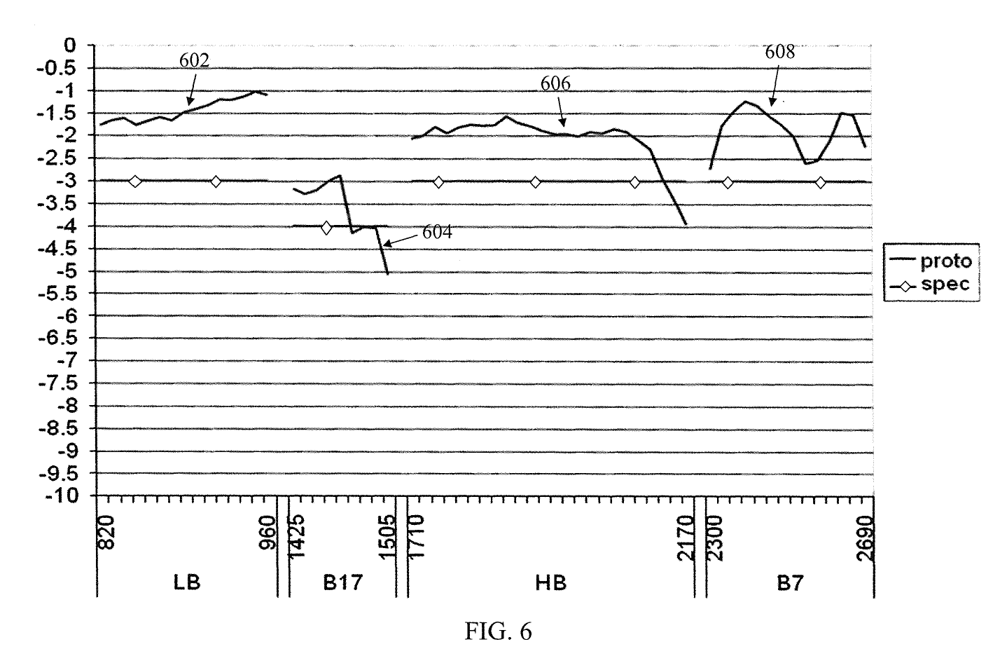

Referring now to FIGS. 5 through 6, performance results obtained during testing by the Assignee hereof of an exemplary antenna apparatus constructed according to the invention are presented.

FIG. 5 shows a plot of (i) free-space return loss S11, S22, and S33 (in dB) as a function of frequency, measured with the three antenna structures constructed in accordance with the triple-feed antenna apparatus 100 of FIG. 1 discussed supra, as well as (ii) the isolation between the respective three feed ports 106, 108, and 110. The vertical lines of FIG. 5 denote the low band 502, high band 504, B11 frequency band 508, and B7 frequency band 506, respectively. The return loss data clearly show the exemplary antenna configuration forming several distinct frequency bands from 600 MHz to 3000 MHz, with the respective antenna radiators showing acceptable return loss within their respective bands 502, 504, and 506. In addition, the data clearly shows strong isolation between the first feed port 106 and the third feed port 110, as well as good isolation between the first feed port 106 and second feed port 108, and between the second port 108 and third feed port 110.

FIG. 6 presents data regarding total efficiency for the low band, B7/B17 band, and high band triple-feed antenna apparatus 100 as described above with respect to FIG. 1. In addition, FIG. 6 provides reference to the minimum total efficiency requirement as listed by the LTE/LTE-A specification for the aforementioned designated frequency bands. Antenna efficiency (in dB) is defined as decimal logarithm of a ratio of radiated and input power:

$$AntennaEfficiency [ dB ] = 10 {log}_{10} ( \frac{Radiated Power}{Input Power} ) \qquad Eqn . ( 1 )$$

An efficiency of zero (0) dB corresponds to an ideal theoretical radiator, wherein all of the input power is radiated in the form of electromagnetic energy. The data in FIG. 6 clearly demonstrates that the first radiator 112 yields high efficiency, as indicated by curve 602. The second radiator 114 yields acceptable efficiency over the designated B17 and B7 bands, as indicated by curve 604 and curve 608. Lastly, the third radiator 116 yields good efficiency over the high band, as illustrated by curve 606. The data in FIG. 6 illustrate that the triple feed antenna embodiments constructed according to the invention advantageously require only minimal amount of tuning in order to satisfy the total efficiency requirements. As will be understood, these efficiency results discussed supra provide only an indication of achievable antenna performance and may change based on specific implementation and design requirements.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A multi-feed antenna apparatus, comprising:
a first antenna element operable in a first frequency region and comprising:
a first radiator; and
a first feed portion, the first feed portion configured to be coupled to a first feed port;
a second antenna element operable in at least a second frequency region and a third frequency region, the second antenna element comprising:
a second radiator;
a second feed portion configured to be coupled to a second feed port; and
a third feed portion configured to be coupled to a third feed port;
wherein:
the second frequency region comprises a first carrier frequency and the third frequency region comprises a second carrier frequency; and
the second and the third feed portions cooperate to: (i) enable inter-carrier aggregation of the first carrier and the second carrier into a single band, and (ii) to obviate diplexer matching specific to said single band.

2. A triple-feed antenna apparatus, comprising:
a first antenna element operable in a lower frequency band and comprising a first feed portion configured to be coupled to a first feed port;
a second antenna element operable in a second frequency band and comprising a second feed portion configured to be coupled to a second feed port; and
a third antenna element operable in an upper frequency band and comprising a third feed portion configured to be coupled to a third feed port;
wherein:
the first and third antenna elements are each configured to form a radiation pattern disposed primarily in a first orientation; and
the second antenna element is configured to form a radiation pattern disposed primarily in a second orientation that is substantially orthogonal to the first.

3. The antenna apparatus of claim 2, further comprising a matching network comprised of:
a first circuit coupled between a radio-frequency (RF) front end of assembly host transceiver and said first feed port;
a second circuit coupled between said RF front end and said second feed port; and
a third circuit coupled between said RF front end and said third feed port.

4. The antenna apparatus of claim 3, wherein:
said first and said second circuits cooperate to reduce electromagnetic coupling between a radiating structure of the first antenna element and a radiating structure of the second antenna element; and
said third and said second circuits cooperate to reduce electromagnetic coupling between a radiating structure of said third antenna element and a radiating structure of said second antenna element.

5. The antenna apparatus of claim 2, wherein:
said first, second and third antenna elements are disposed on a common carrier, at least a portion of the carrier being configured substantially parallel to a ground plane;
the radiation pattern of the first and third antenna elements each comprise an axis of maximum radiation that is substantially perpendicular to said ground plane; and
the radiation pattern of the second antenna element comprises an axis of maximum radiation substantially parallel to said ground plane.

6. The antenna apparatus of claim 5, wherein the disposition of said axes of maximum radiation of the first, the second, and the third antenna elements enable electrical isolation of the first antenna element from said third antenna element.

7. The antenna apparatus of claim 5, wherein the disposition of said axes of maximum radiation of the first, the second, and the third antenna elements enable substantial electrical isolation between:
the first antenna element and said third antenna element;
the first antenna element and said second antenna element; and
the second antenna element and said third antenna element.

8. The antenna apparatus of claim 2, wherein the first antenna element and the third antenna element each comprise a quarter-wavelength planar inverted-L antenna (PILA); and
said second antenna element comprises a half-wavelength loop antenna.

9. The antenna apparatus of claim 2, wherein the second antenna element further comprises a radiator branch configured to form a loop structure configured to effect a resonance, said resonance configured to expand said second frequency band; and
said radiating branch and said loop structure are configured spaced yet parallel to a ground plane of the antenna apparatus.

10. The antenna apparatus of claim 2, further comprising a common carrier, said common carrier comprising a dielectric element having a plurality of surfaces, and wherein:
the first antenna element and the third antenna element are disposed at least partly on a first surface of said plurality of surfaces; and
the second antenna element is disposed at least partly on a second surface of said plurality of surfaces, said second surface being disposed substantially parallel to a ground plane of the antenna apparatus, and said first surface is disposed substantially perpendicular to said ground plane.

11. The antenna apparatus of claim 10, wherein:
said first antenna element is disposed proximate a first edge of said first surface; and
said third antenna element is disposed proximate a second end of said first surface, said first end being disposed opposite said second end.

12. The antenna apparatus of claim 11, wherein:
said first antenna element is disposed at least partly on a third surface of said plurality of surfaces, said third surface proximate said first end; and
said third antenna element is disposed at least partly on a fourth surface of said plurality of surfaces, said fourth surface proximate said second end.

13. A radio frequency communications device, comprising:
an electronics assembly comprising a ground plane and one or more feed ports; and
a multiband antenna apparatus, the antenna apparatus comprising:
a first antenna structure comprising a first radiating element and a first feed portion coupled to a first feed port;
a second antenna structure comprising a second radiating element and a second feed portion coupled to a second feed port;
a third antenna structure comprising an third radiating element and a third feed portion coupled to a third feed port; and
wherein:
the second antenna structure and second feed port are disposed substantially between said first and third antenna structures.

14. The radio frequency communications device of claim 13, wherein said antenna apparatus is disposed proximate a bottom end of the ground plane.

15. The radio frequency communications device of claim 13, wherein said first and third radiating elements have radiation patterns which are substantially orthogonal to a radiation pattern of the second radiating element.

16. The radio frequency communications device of claim 15, wherein said substantially orthogonal radiation patterns provide sufficient antenna isolation between each radiating element to enable operation of the device in at least three distinct radio frequency bands.

17. A method of tuning a multi-feed antenna having first, second and third radiating elements and associated first, second, and third feed ports and matching circuits, the method comprising:
tuning a reactance of at least one of the matching circuits so as to create a dual resonance response in the radiating element associated therewith.

18. The method of claim 17, wherein the tuning is accomplished via at least selection of one or more capacitance values within said at least one matching circuit.

19. The method of claim 17, wherein the first and the third radiating elements each comprise a planar inverted-L antenna (PILA)-type element, and the tuning a reactance of at least one matching circuit comprises tuning the reactance associated with the first and the third circuits so as to produce multiple frequency bands within the emissions of the first and the third elements.

20. A method of radiator isolation for use in a multi-feed antenna apparatus of a radio frequency device, the antenna comprising first, second, and third antenna radiating elements, and at least first, second, and third feed portions, the method comprising:
electrically coupling the first feed point to the first radiating element, said coupling configured to effect a first radiation pattern having maximum sensitivity along a first axis;
electrically coupling the second feed point to the second radiating element, said electric coupling configured to effect a second radiation pattern having maximum sensitivity along a second axis; and
electrically coupling the third feed portion to the third radiating element, said coupling configured to effect a third radiation pattern having maximum sensitivity along said first axis;
wherein:
said second axis is configured orthogonal to said first axis; and
said configurations cooperate to effect isolation of the first radiating element from the third radiating element.
